(19) United States
(12) Patent Application Publication
(10) Pub. No.: US 2026/0356351 A1
(43) Pub. Date: Nov. 12, 2026

(54) STEERING CONTROL DEVICE AND METHOD OF VEHICLE

(71) Applicant: HL MANDO CORPORATION, Gyeonggi-do (KR)

(72) Inventors: Jinsoo KIM, Gyeonggi-do (KR); Youngeun CHO, Gyeonggi-do (KR)

(21) Appl. No.: 19/674,102

(22) Filed: May 11, 2026

(30) Foreign Application Priority Data
May 12, 2025 (KR) 10-2025-0060935

(51) Int. Cl. B60W 30/045; B60W 10/18; B60W 10/20; B60W 50/02

(52) U.S. Cl. CPC B60W 30/045; B60W 10/18; B60W 10/20; B60W 50/0225; B60W 2520/14; B60W 2520/28; B60W 2540/18

(57) ABSTRACT

A steering control device of a vehicle equipped with a rear-wheel steering (RWS) system and a braking system includes an open-loop control module configured to control at least one of the RWS system or the braking system in a feed-forward manner based on a control input value determined according to at least one of a steering angle, a vehicle speed, and a steering angle speed measured from a sensor, a closed-loop control module configured to determine a target yaw rate based on information acquired from the sensor, determine a control signal to follow the target yaw rate, and control at least one of the RWS system or the braking system in a feedback manner, and a control method selection module that selectively operates the open-loop control module or the closed-loop control module based on a comparison between a measured yaw rate detected by the sensor and a reference yaw rate.

### CROSS REFERENCE TO RELATED APPLICATION

This application claims priority from Korean Patent Application No. 10-2025-0060935, filed on May 12, 2025, which is hereby incorporated by reference for all purposes as if fully set forth herein.

### TECHNICAL FIELD

An embodiment of the present disclosure relates to a steering control device and method of a vehicle.

### BACKGROUND

In general, a steering system of a vehicle may refer to a system capable of changing a steering angle of a wheel based on a steering force (or rotational force) applied to a steering wheel by a driver of the vehicle. The steering system may be implemented by various manners, for example, an electronic steering device has been applied to a vehicle in order to reduce a steering force of a steering wheel to ensure stability of a steering state.

Recently, as a vehicle chassis system of a by-wire method provides high efficiency, a steer-by-wire (SbW) system and a brake-by-wire (BbW) system are being actively developed.

In particular, in the case of the SbW system, it is mainly applied to the front-wheels of the vehicle, and a steering wheel operation of a driver and a rack actuator operation are performed by using an electric motor signals without an intermediate physical connection (e.g., steering column). Therefore, if a failure such as a communication failure occurs, there may be difficult to achieve target steering for the driver or autonomous driving.

In this aspect, the importance of securing a redundancy function in preparation for failure of a front-wheel steering system or front-wheel SbW system is further emphasized.

Therefore, there is a need for a method capable of performing safe steering in the case of a failure in the front-wheel steering system or front-wheel SbW system.

### SUMMARY

An object of the embodiments of the present disclosure is to provide a steering control device and method of a vehicle capable of controlling a vehicle to a target steering through a partial braking and a rear-wheel steering without additional mechanical design in the event of a failure in the front-wheel steering system in a vehicle equipped with a front-wheel steering system, a rear-wheel steering (hereinafter also referred to as ‘RWS’) system, and a braking system.

An object of the embodiments of the present disclosure is to provide a steering control device and method of a vehicle capable of controlling the steering of a vehicle by providing rear-wheel steering input values to a steering motor of the rear-wheel steering system (RWS) and providing a partial braking command value to a braking system to in the event of a failure of the steer-by-wire (hereinafter also referred to as ‘SbW’) system, which is a front-wheel steering system.

Another object of the embodiments of the present disclosure is to provide a steering control device and method of a vehicle capable of securing vehicle stability by selectively performing open-loop control and closed-loop control for the rear-wheel steering system (RWS) and the partial braking system according to the vehicle's behavior state determined based on yaw rate information.

In accordance with an aspect of the present disclosure, an embodiment may provide a steering control device of a vehicle equipped with a rear-wheel steering (RWS) system and a braking system, including: an open-loop control module configured to control at least one of the RWS system or the braking system in a feed-forward manner based on a control input value determined according to at least one of a steering angle, a vehicle speed, and a steering angle speed measured from a sensor provided in the vehicle; a closed-loop control module configured to determine a target yaw rate based on information acquired from the sensor, determine a control signal to follow the target yaw rate, and control at least one of the RWS system or the braking system in a feedback manner; and a control method selection module that selectively operates the open-loop control module or the closed-loop control module based on a comparison result between a measured yaw rate detected by the sensor and a reference yaw rate.

In accordance with another aspect of the present disclosure, an embodiment may provide a steering control method of a vehicle equipped with a rear-wheel steering (RWS) system and a braking system, including: a control method selection step of determining a control method of at least one of the RWS system or the braking system based on a comparison result between a measured yaw rate using a sensor equipped in the vehicle and a reference yaw rate; an open-loop control step of controlling, by selected and performed by the control method selection step, at least one of the RWS system or the braking system in a feed-forward manner based on a control input value determined according to at least one of a steering angle, a vehicle speed, and a steering angle speed measured from a sensor provided in the vehicle; and a closed-loop control step of determining, by selected and performed by the control method selection step, a target yaw rate based on information acquired from the sensor, determining a control signal to follow the target yaw rate, and control at least one of the RWS system or the braking system in a feedback manner.

According to the present disclosure, in a vehicle equipped with a front-wheel steering system, a rear-wheel steering (RWS) system, and a braking system, if a failure occurs in the front-wheel steering system, a vehicle steering control device and method may control the vehicle to a target steering direction through partial braking and rear-wheel steering without additional mechanical design.

Furthermore, according to the present disclosure, if a failure occurs in a steer-by-wire (SbW) system, which is a front-wheel steering system, a steering control device and method may control the steering of the vehicle by providing a rear-wheel steering input value or control signal to a steering motor of the rear-wheel steering system and a partial braking input value or control signal to the braking system.

More specifically, according to the present disclosure, it is possible to secure the vehicle stability in the event of a front-wheel steering system failure by selectively performing open-loop control and closed-loop control for the rear-wheel steering (RWS) system and the partial braking system according to the vehicle's behavioral state determined based on yaw rate information, etc.

The effects of the embodiments of the present disclosure are not limited to the effects described in the present disclosure, and other effects not mentioned will be clearly understood by those skilled in the art from the description or the claims.

### BRIEF DESCRIPTION OF THE DRAWINGS

FIG. 1 is a block diagram schematically illustrating a steer-by-wire (SbW) system, which is an example of a front-wheel steering system to which the present disclosure may be applied.

FIG. 2 illustrates a control system of a vehicle to which the present disclosure may be applied.

FIG. 3 is a block diagram of a steering control device according to an embodiment of the present disclosure.

FIG. 4 is a diagram illustrating control method selection conditions of a steering control device according to an embodiment of the present disclosure.

FIG. 5 is a configuration diagram of an open-loop control module according to an embodiment of the present disclosure.

FIG. 6 illustrates an example of a rear-wheel steering input value and a partial braking input value generated by an open-loop control module if the front-wheel steering system is in a center-locking failure state in an embodiment of the present disclosure.

FIG. 7 illustrates an example of a rear-wheel steering input value and a partial braking input value generated by an open-loop control module if the front-wheel steering system is in a free-rolling failure state in an embodiment of the present disclosure.

FIGS. 8A to 8C illustrate examples of a tuning process of a tuning module included in an open-loop control module of a steering control device according to an embodiment of the present disclosure.

FIG. 9 is a block diagram of a closed-loop control module according to an embodiment of the present disclosure.

FIG. 10 to FIG. 12 illustrate a process in which a closed-loop control module according to an embodiment of the present disclosure performs a rear-wheel steering control after a partial braking control.

FIG. 13 to FIG. 15 illustrate a process in which a closed-loop control module according to an embodiment of the present disclosure performs a partial braking control after a rear-wheel steering control.

FIG. 16 is a flowchart of a steering control method according to an embodiment of the present disclosure.

FIG. 17 is a control block diagram illustrating the overall operation of a steering control system according to an embodiment of the present disclosure.

FIG. 18 illustrates an example of a hardware configuration of a steering control device according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Unless otherwise defined, all terms (including technical and scientific terms) used in the present disclosure will be used in a meaning that can be commonly understood by those of ordinary skill in the art to which the embodiments of the present disclosure belong. In addition, terms defined in commonly used dictionaries should be not interpreted ideally or excessively unless explicitly specifically defined. In addition, terms to be described later are terms defined in consideration of functions in the embodiments of the present disclosure, which may vary according to the intention or custom of a user or operator. Therefore, the definition thereof should be made based on the contents throughout this specification.

If a driver manipulates the steering wheel to steer the vehicle, the wheel does not rotate around the center of the ground contact surface, which is the point of contact between the wheel and the ground, but rotates around a portion slightly deviated from the center of the ground contact surface according to the kingpin axis. In this specification, “a scrub radius” may mean the distance from the center of the ground contact surface to the center of rotation. In this case, if the center of rotation is toward a center of the vehicle relative to the center of the ground contact surface, it is referred to as a positive scrub radius. On the other hand, if the center of rotation is on the outside of the vehicle relative to the center of the ground contact surface, it is referred to as a negative scrub radius.

Hereinafter, it will be described a steering control device and method according to embodiments of the present disclosure with reference to the accompanying drawings.

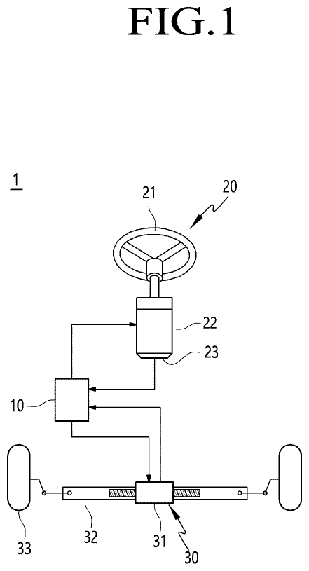

FIG. 1 is a block diagram schematically illustrating a steer-by-wire (SbW) system, an example of a front-wheel steering system to which the present disclosure may be applied.

A front-wheel steering system of a vehicle may be a steering system in which a steering wheel and a rack bar are mechanically connected, depending on whether a mechanical linkage is connected between the steering input actuator and the steering output actuator.

Another front-wheel steering system, a steer-by-wire (SbW) system in which there is no mechanical connection between the steering wheel and the wheels (or rack bar), may be used.

A SbW system is an electronic steering system that transmits and receives electrical signals via wires, cables, etc., instead of a mechanical power transmission device between the steering wheel and the wheels of the vehicle.

The following description will focus on an SbW system as an example of a front-wheel steering system, but is not limited thereto.

That is, the front-wheel steering system of the present disclosure may be an electric power steering (EPS) system, such as a column-type electric power steering system or a rack-type electric power steering system, in addition to the SbW system.

Referring to FIG. 1, the SbW system 1 as a front-wheel steering system according to an embodiment may include a steering control device, a steering feedback actuator (SFA), and a road wheel actuator (RWA).

The SbW system 1 according to an embodiment may refer to a system that controls the vehicle driving direction by adjusting the direction of the front-wheels of a vehicle equipped with the steering system 1 according to the rotation angle of a steering wheel 21 operated by a driver.

The SbW system as a front-wheel steering system according to the present disclosure illustrated in FIG. 1 may include an SFA 20, a steering control device 10, and an RWA 30. As described above, in the case of an SbW system, the SFA 20 and the RWA 30 may be mechanically separated.

The SFA 20 may refer to a device into which steering information intended by the driver is input. As described above, the SFA 20 may include a steering wheel 21, a steering shaft 22, and a reaction motor 23. In addition, although not illustrated, the SFA 20 may further include a steering gear that transmits the rotational force of the reaction motor 23 to the steering shaft 22.

The steering wheel 22 may rotate between a left steering lock position and a right steering lock position with the steering shaft 22 as the rotation axis. Here, the locking position may refer to a limit point to which the steering wheel can move. The locking position may be implemented by a steering damper, etc.

The reaction motor 23 may receive a command current from the steering control device 10 and provide a feedback torque to the steering wheel 21. In an embodiment, the reaction motor 23 may receive a command current from the steering control device 10 and drive at a rotation speed indicated by the command current to generate a feedback torque, and transmit the feedback torque to the steering wheel 21 through a worm and a worm wheel.

The SFA 20 may include sensors such as a steering angle sensor for detecting a steering angle of the steering wheel, a torque sensor for detecting driver torque, and a steering angle speed sensor for detecting a steering angle speed of the steering wheel.

The steering control device 10 may receive steering information from each sensor included in the SFA 20, calculate a control value, and output an electrical signal indicating the control value to the RWA 30. Here, the steering information may refer to information including at least one of a steering angle, a steering angle speed, and a driver torque.

Meanwhile, the steering control device 10 may receive feedback on driving information (e.g., rack position information) actually output from the RWA 30, calculate a control value, and provide an electrical signal indicating the control value to the SFA 20. The reaction motor 23 of the SEA 20 may output a reaction force corresponding to the control value, thereby providing a reaction force (e.g., steering feeling) to the driver.

The RWA 30 may refer to a device that drives an actual vehicle to steer. The RWA 30 may include a steering motor 31, a rack 32, a front-wheel 33, a vehicle speed sensor, and a rack position sensor.

In addition, the SFA 20 and the RWA 30 may further include a motor torque sensor capable of detecting a motor torque of the reaction motor 23 and the steering motor 31.

The steering motor 31 may move the rack 32 in the axial direction. Specifically, the steering motor 31 may receive a command current from the steering control device 10 and is driven, thereby causing the rack 32 to move linearly in the axial direction. That is, the rack 32 may move linearly between the left lock end, which is the left movement limit point, and the right lock end, which is the right movement limit point.

The rack 32 may be linearly moved by driving the steering motor 31, and the front-wheels 33 may be steered left or right through the linear motion of the rack 32.

Although not illustrated, the SbW system 1 may further include a clutch, which can separate or combine the SFA 20 and the RWA 30. Here, the clutch may be operated under the control of the steering control device 10.

Meanwhile, if the front-wheel steering system is the SbW system 1 and the vehicle is driving in autonomous driving mode, the SbW system 1 may perform steering control of the vehicle by controlling only the RWA 30, or by controlling both the SFA 20 and the RWA 30.

Hereinafter, embodiments of the present disclosure will be described on the assumption that the front-wheel system is the SbW system. However, the following description may be applied to all types of front-wheel steering systems other than SbW.

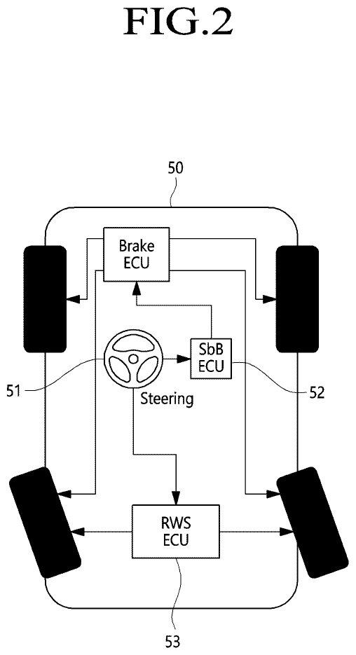

FIG. 2 illustrates the control system of a vehicle to which the present disclosure may be applied.

Referring to FIG. 2, a vehicle 50 may include a steer-by-brake (SbB) electronic control unit (ECU) 52 that controls the SbB function, a brake ECU 54 that controls the vehicle's braking system, and a rear-wheel steering (RWS) ECU 53 that controls the RWS system. If a driver performs a steering operation via the steering wheel 51, the vehicle's steering is controlled based on a target steering angle corresponding to the steering operation. In the present disclosure, a braking system may be used interchangeably with a brake system.

The SbB ECU 52 provides a function for controlling the vehicle's steering through a partial braking control or partial braking control. By generating a difference in longitudinal force between the left and right wheels of a moving vehicle through the partial braking control or the partial braking control, which applies a difference in braking force to the left and right wheels, a yaw moment and lateral force are generated, which can be used to control the steering of the vehicle. In this case, the SbB ECU 52 can generate a partial braking control signal and output the partial braking control signal to the brake ECU 54 that controls the braking system. In this specification, a differential braking and a partial braking can be used interchangeably.

The RWS ECU 53 may provide a function that actively controls the rear-wheel steering angle according to the steering angle of the front-wheels depending on the driving conditions of the vehicle. If the vehicle is traveling at a low to medium speed, the RWS ECU 53 can steer the rear-wheels in the opposite direction to the front-wheels to secure a smaller turning radius. If the vehicle is traveling at a high speed, the RWS ECU 53 can steer the rear-wheels in the same direction as the front-wheels to secure stability in the turning driving.

In FIG. 2, each ECU is illustrated as being independently provided, but this is not limited thereto. Each ECU may be implemented by being integrated into a domain control unit (DCU).

In this way, assuming that a braking system for proving a partial braking control and a rear-wheel steering system are provided, embodiments of the present disclosure may provide a device and method capable of performing steering control in an emergency situation such as a failure of the front-wheel steering system by integrating the control systems.

Basically, the steering control device according to the present disclosure may control the steering of a vehicle by utilizing the rear-wheel steering function of the rear-wheel steering (RWS) system and the partial braking function of the braking system if a failure occurs in the front-wheel steering system provided in the vehicle.

In this case, if the actual yaw rate (i.e., measured yaw rate) of the vehicle is less than a reference yaw rate determined by the lateral dynamic model of the vehicle, the steering control device may perform open-loop control of a feed-forward method. In addition, if the actual yaw rate is greater than the reference yaw rate, the steering control device may perform closed-loop control of a feedback method.

In this way, according to the embodiments of the present disclosure, the steering control device may selectively perform the open-loop control or the closed-loop control for the rear-wheel steering system and the partial braking system according to the yaw behavior of the vehicle, thereby ensuring steering stability of the vehicle in the event of a failure of the front-wheel steering system.

If the front-wheel steering system of the vehicle fails and front-wheel steering is impossible, steering stability can be secured through integrated control of the left and right partial braking of the wheels and rear-wheel steering.

In this case, the target yaw rate, which is the control reference, may be determined based on the driver's steering intent, i.e., the magnitude of the steering angle resulting from steering wheel operation, and feedback control (i.e., closed-loop control) may be performed so that the vehicle's actual yaw rate tracks the target yaw rate using the rear-wheel steering function or partial braking function.

This enables a failsafe or failover function that enables vehicle steering even in the event of a front-wheel steering system failure.

However, in the case of such a failsafe or failover function based on feedback control, even under ideal conditions, sensitive and excessive feedback control may be performed throughout the entire system, thereby generating unnecessary control inputs causing a sense of incongruity to the driver and potentially leading to system instability.

For example, if the vehicle's alignment is misaligned, control performance may be unstable.

Furthermore, even if there is a slight difference between the vehicle's actual yaw rate and the target yaw rate, which is the control reference, sensitive control inputs may be generated, thereby generating the excessive control inputs even in situations where feedback control is unnecessary, such as understeer.

Therefore, in the embodiments of the present disclosure, open-loop control or feedforward control can be used to control the RWS system and braking system by pre-setting partial braking force and rear-wheel steering control inputs based on the driver's steering intent.

The open-loop control or feedforward control may allow for easy calculation of control inputs based on the driver's steering input, resulting in a simple structure and ease of tuning.

However, the open-loop control method may not be able to respond to constantly changing environments and disturbances, such as low-friction road surfaces, slopes, and strong winds, which deviate from ideal conditions, thereby leading to problems in ensuring vehicle stability.

Therefore, in embodiments of the present disclosure, a steering failover system is proposed that combines the two control methods, namely, the open-loop control and the closed-loop control, to secure the advantages of each control method.

The steering control method according to embodiments of the present disclosure is conceptually described as follows.

First, a steering control device may determine a reference yaw rate in real time through a lateral dynamics model of a vehicle based on the vehicle speed measured in real time and the driver's steering wheel operation signal (e.g., steering angle information).

The steering control device may compare the determined reference yaw rate with the actual yaw rate measured from the vehicle, select one of open-loop control and closed-loop control based on the comparison result, and switch the control signal or control value corresponding to the selected control method to be input to the RWS system or the braking system.

The open-loop control may operate in a region where the actual yaw rate of the vehicle is less than the reference yaw rate. In addition, through this open-loop control, the steering control unit may determine a rear-wheel steering input and partial braking input values through a pre-designed open-loop model or map based on the steering angle or steering angle speed and vehicle speed, and transmit the rear-wheel steering input and partial braking input values to the vehicle's lower-level controllers (i.e., the brake ECU and the RWS ECU). Here, the open-loop model or map may be designed by reflecting numerous actual vehicle tests and the hardware limitations of the vehicle to which the system is applied. This open-loop control may be expressed as a steering control.

The closed-loop control may operate in a region where the actual yaw rate of the vehicle exceeds the reference yaw rate, and the steering control unit may determine a rear-wheel steering control signal and a partial braking control signal through a feedback controller so as for the actual vehicle's yaw rate to follow the target yaw rate, and transmit the determined control signals to the vehicle's lower-level controllers (e.g., the brake ECU and the RWS ECU). Here, feedback control may be designed using various feedback techniques (e.g., PID control, optimal control, and model predictive control).

Hereinafter, the functions of the steering control device 100 according to the present disclosure will be described in detail with reference to the drawings.

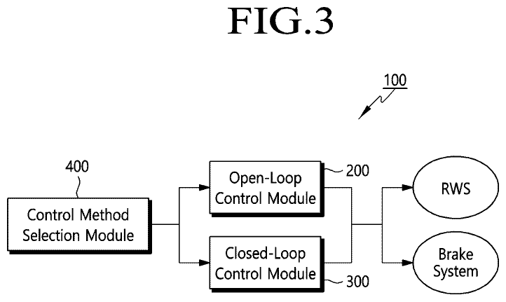

FIG. 3 is a block diagram of a steering control device 100 according to an embodiment of the present disclosure.

Referring to FIG. 3, the steering control device 100 may be configured to include an open-loop control module 200, a closed-loop control module 300, and a control method selection module 400. The control method selection module 400 may be implemented with one or more processors.

The open-loop control module 200 may control one or more of the rear-wheel steering system or the braking system in a feed-forward manner based on a control input value determined based on one or more of the steering angle, vehicle speed, or steering angle speed measured by a sensor.

In addition, the closed-loop control module 300 may determine a target yaw rate based on information acquired from a sensor unit, and generate control signals to track the target yaw rate, thereby controlling at least one of the rear-wheel steering system or the braking system in a feedback manner.

The control method selection module 400 may selectively select and operate one of the open-loop control module or the closed-loop control module based on a comparison result between the measured yaw rate detected by the sensor and a preset reference yaw rate.

The control method selection module 400 may activate the open-loop control module 200 to supply a rear-wheel steering input value and a partial braking input value to the rear-wheel steering system and the braking system, respectively, if the measured yaw rate is lower than or equal to the reference yaw rate.

In this specification, the control input values provided to the rear-wheel steering system and braking system in a feedforward manner by the open-loop control module 200 may be expressed as a rear-wheel steering input value RWS_{INPUT} and a partial braking input value DB, respectively.

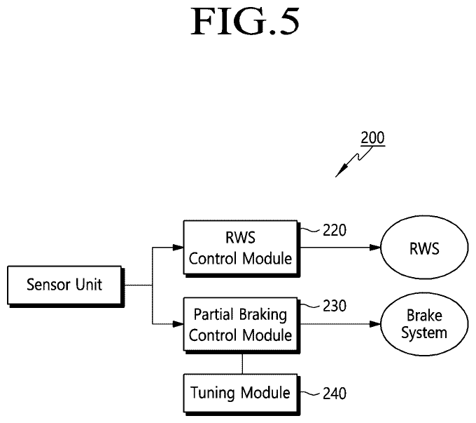

The detailed configuration of this open-loop control module 200 will be described in more detail below based on FIGS. 5 to 8.

Meanwhile, the control method selection module 400 may activate the closed-loop control module 300 to supply a rear-wheel steering control signal and a partial braking control signal to the rear-wheel steering system and braking system, respectively, if the measured yaw rate is greater than the reference yaw rate.

In this specification, the control signals provided to the rear-wheel steering system and braking system in a feedback manner by the closed-loop control module 300 may be expressed as a rear-wheel steering control signal and a partial braking control signal, respectively.

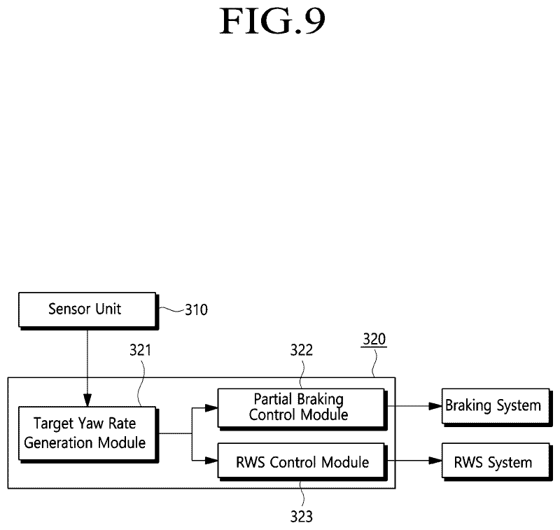

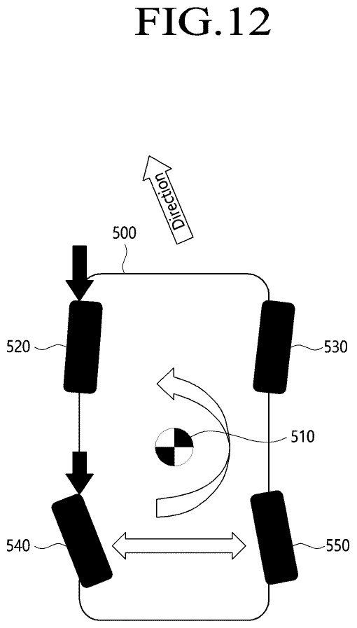

The detailed configuration of this closed-loop control module 300 will be described in more detail below with reference to FIGS. 9 to 15.

Meanwhile, according to an embodiment of the present disclosure, the vehicle may further include a steer-by-wire (SbW) system as a front-wheel steering system, and the steering control device 100 may operate only when a failure occurs in the SbW system.

However, the embodiment of the present disclosure is not limited to the SbW system as a front-wheel steering system and may be applied to a vehicle including any type of front-wheel steering system.

In an embodiment of the present disclosure, the reference yaw rate used to select a control method (i.e., open-loop control and closed-loop control) may be determined by a lateral dynamic model of the vehicle.

As an example, the reference yaw rate may be determined by a lateral dynamic model of the vehicle. The rear-wheel steering (RWS) system according to an embodiment of the present disclosure may be the rear-wheel steering system described in FIG. 2 and may further include an RWS ECU that controls the RWS system.

The rear-wheel steering (RWS) system may include a rear-wheel rack screw connected between the rear-wheels, a rear-wheel steering motor, and a power transmission mechanism that linearly moves the rear-wheel rack screw using the rotational force of the steering motor.

The power transmission mechanism may include a ball nut connected to the rear-wheel rack screw, and a belt structure or gear structure for power transmission between the ball nut and the rear-wheel steering motor.

However, the rear-wheel steering system is not limited thereto, and may include any type of steering system that enables rear-wheel steering independently of the front-wheel steering system.

A braking system in the embodiment of the present disclosure may be a braking system having a steer-by-brake (SbB) function as described in FIG. 2, and may include an SbB ECU or brake ECU that controls the braking system.

In addition, a vehicle to which the steering control device 100 according to the embodiment of the present disclosure may be applied may further include a front-wheel steering system for controlling the steering of the front-wheels.

The front-wheel steering system may be the SbW steering system as described in FIG. 1, but is not limited thereto.

Although not illustrated, the steering control device 100 according to the embodiment of the present disclosure or a vehicle equipped with the steering control device may include a sensor unit including various sensors that acquire information about the vehicle and information about the exterior of the vehicle.

According to one example, the sensor unit may include one or more sensors that detect information about the vehicle, such as a steering angle sensor that detects information about the rotation angle of the steering wheel of the vehicle, a steering angle speed sensor that detects the steering angle speed of the steering wheel, a rack position sensor that detects information about the position of the rack, a motor torque sensor that detects the torque of a motor within the steering system, a current sensor that detects current within the steering system, a yaw rate sensor that detects the yaw or yaw rate of the vehicle, a vehicle speed sensor that detects the driving speed of the vehicle, and an acceleration sensor that measures the lateral acceleration of the vehicle.

In addition, the sensor unit may further include various image sensors or range sensors, such as a camera, lidar, or radar sensor, for detecting other vehicles or lanes outside the vehicle.

In addition, although not illustrated, the steering control device 100 according to an embodiment of the present disclosure may further include a failure detection module that detects a failure of the front-wheel steering system.

The failure detection module may detect a failure in the front-wheel steering system.

For example, information on the occurrence of a failure, such as a communication failure within the SbW system, which is an example of a front-wheel steering system, can be acquired from a separate device and transmitted to the failure detection module. Alternatively, the failure detection module may directly determine whether a failure has occurred in steering system based on a signal output from a sensor unit or a signal transmitted and received within the steering system.

The steering control device 100 according to an embodiment of the present disclosure may operate only if a failure occurs in the front-wheel steering system.

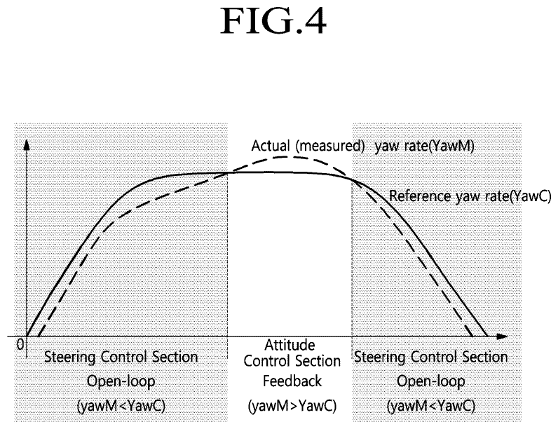

FIG. 4 illustrates control method selection conditions of a steering control device according to an embodiment of the present disclosure.

Referring to FIG. 4, the steering control device 100 according to the present disclosure may select and control the open-loop control module 200 to operate if the measured yaw rate YawM of the vehicle is smaller than or equal to the reference yaw rate YawC determined by the lateral dynamic model of the vehicle.

The reference yaw rate YawC indicated by a solid line in FIG. 4 may vary depending on time or environment, and the actual yaw rate YawM of the vehicle indicated by a dotted line in FIG. 4 may also vary depending on time or environment.

In this case, in a steering control section where the actual yaw rate YawM of the vehicle is smaller than or equal to the reference yaw rate YawC, the open-loop control can be performed, which performs rear-wheel steering control and partial braking control using predetermined input values according to the steering angle, steering angle speed, and vehicle speed at that point in time.

That is, in the left and right steering control section (e.g., section where YawM≤YawC) of FIG. 4, the steering control device 100 of the present disclosure can perform feed-forward control using the open-loop control module 200.

Meanwhile, in the attitude control section (e.g., section where YawM>YawC) where the yaw rate YawM of the vehicle is greater than the reference yaw rate YawC, i.e., the central region of FIG. 4, the steering control device 100 according to the present disclosure may select and control the closed-loop control module 300 to operate.

That is, if the actual yaw rate YawM of the vehicle is greater than the reference yaw rate YawC, the steering control device 100 according to the present disclosure may perform rear-wheel steering control and partial braking control by feedback control that follows the target yaw rate.

In the embodiment of the present disclosure, the reference yaw rate YawC may be determined by a lateral dynamic model of the vehicle.

As an example, the reference yaw rate YawC or γ_{ref} may be determined by, but is not limited to, the Equation 1 below.

$${γ}_{k} = {\{ \frac{- 2 ( {C}_{af} {I}_{f} + {C}_{ar} {I}_{r} )}{{I}_{z} {V}_{x}} {V}_{y} + ( \frac{- 2 ( {C}_{af} {I}_{f}^{2} + {C}_{ar} {I}_{r}^{2} )}{{I}_{z} {V}_{x}} + \frac{1}{dt} ) γ + \frac{{I}_{f} ( 2 {C}_{af} + {mr}_{eff} {\dot{ω}}_{w} )}{{I}_{z}} {δ}_{f} - \frac{{I}_{r} ( 2 {C}_{ar} + {mr}_{eff} {\dot{ω}}_{w} )}{{I}_{z}} {δ}_{r} - \frac{D}{2 {I}_{z}} ( Δ {F}_{x}^{◻} ) \}}_{k - 1} * dt \qquad [ Equation 1 ]$$

In the Equation 1, C_{af}, Cₐᵣ represent the cornering stiffness of the front and rear-wheels, respectively, l_{f}, lᵣ represent the distance from the vehicle's center of gravity to the front and rear-wheels, I_{z} represents the moment of inertia of the vehicle (unit of kg*m₂), Vₓ, V_{y} represent the longitudinal and lateral velocities of the vehicle, dt represents the period (e.g., about 0.01 s), m represents the gross weight of the vehicle, r_{eff} represents the effective tire radius, \dot{ω}_{w} represents the rotational wheel acceleration (unit of rad/s₂), Of represents the front-wheel steering angle, δᵣ represents the rear-wheel steering control input, D represents the distance between the left and right wheels, and ΔFₓ represents the partial braking input.

However, the reference yaw rate in the embodiment of the present disclosure is not limited to the Equation 1, and may be determined based on any lateral dynamic model that models vehicle behavior.

FIG. 5 is a configuration diagram of an open-loop control module 200 according to an embodiment of the present disclosure.

Referring to FIG. 5, the open-loop control module 200 of the steering control device 100 according to the embodiment of the present disclosure may include a rear-wheel steering control module 220 and a partial braking control module 230.

In addition, the open-loop control module 200 may further include a tuning module 240.

The rear-wheel steering control module 220 of the open-loop control module 200 may receive steering angle and vehicle speed information measured by the sensor unit, determine a rear-wheel steering input value based on the steering angle and vehicle speed, and provide the determined rear-wheel steering input value to the RWS system.

In addition, the partial braking control module 230 of the open-loop control module 200 may determine a partial braking input value based on the steering angle or the steering angle speed and vehicle speed. In this case, the steering angle speed may be time-varying quantity of the steering angle. In addition, the partial braking control module 230 may provide the determined partial braking input value to the braking system to steer the vehicle.

As an example, the open-loop control module 200 may control at least one of the rear-wheel steering control module 220 or the partial braking control module 230 to determine a rear-wheel steering input value and a partial braking input value only if the actual yaw rate of the vehicle measured by the yaw rate sensor included in the sensor unit is less than or equal to the reference yaw rate, and may provide the input values to the RWS system or the braking system.

As an example, the rear-wheel steering input value RWS_{INPUT} provided by the rear-wheel steering control module 220 of the open-loop control module 200 to the RWS system is for driving a rear-wheel steering motor included in the RWS system, and may be determined based on the steering angle (e.g., steering angle sensing value; SAS), which is the amount of steering wheel operation by the driver, and the vehicle speed.

The rear-wheel steering input value RWS INPUT may correspond to the rear-wheel steering angle, which is the turning angle of the rear-wheels.

As an example, the rear-wheel steering input value RWS_{INPUT} may be determined to be proportional to the steering angle SAS and inversely proportional to the vehicle speed.

Specifically, the rear-wheel steering input value RWS_{INPUT} may be determined by, but is not limited to, the following Equation 2.

$${RWS}_{input} = ( - or + ) {W}_{V\_ 1} \times \frac{{RWS}_{max}}{{SAS}_{thres}} \times SAS \qquad [ Equation 2 ]$$

In Equation 2, RWSₘₐₓ represents the maximum rear-wheel steering angle that the RWS system can provide, which may be approximately −5 degrees or +5 degrees. SASₜₕᵣₑₛ represents the steering angle of the steering wheel at the point where the maximum rear-wheel steering angle begins, and SAS represents the actual steering angle of the vehicle.

Equation 2, W_{V_1} represents a first weight inversely proportional to vehicle speed, which may be expressed as in Equation 3 below, but is not limited thereto.

$${W}_{V\_ 1} = 1 - \frac{1}{{G}_{V 1}} ( {V}_{x} - {V}_{s 1} ) \qquad [ Equation 3 ]$$

In Equation 3, Gᵥ₁ may represent a first speed gain value, Vₓ may represent a vehicle speed, and Vₛ₁ may represent a first reference vehicle speed.

That is, as in Equations 2 and 3, the rear-wheel steering input value RWS_{INPUT}, Which is a control signal applied to the RWS system by the rear-wheel steering control module 220 of the open-loop control module 200, may be determined to be proportional to the steering angle SAS and inversely proportional to the vehicle speed.

The partial braking input value (hereinafter abbreviated as “DB”) applied to the braking system by the partial braking control module 230 of the open-loop control module 200 may include a first partial braking input value DB1 to compensate for the lack of rear-wheel steering force due to the rear-wheel steering input value RWS_{INPUT}, and a second partial braking input value DB2 to ensure vehicle responsiveness in the case that the steering angle speed exceeds a threshold steering angle speed.

In general, it is difficult for the RWS system to secure vehicle steering performance equivalent to that of the front-wheel steering system.

Therefore, if the front-wheel steering system fails and a steering angle exceeding a certain level is required, it is difficult to secure sufficient steering performance with the RWS system alone. Therefore, the partial braking may be applied to one or more of the left and right wheels of the vehicle using the first partial braking input value DB1, thereby securing the insufficient steering performance.

Furthermore, if the driver steers rapidly, i.e., if the steering angle speed or steering angular acceleration exceeds a certain level, it is necessary to provide a more immediate steering moment to ensure steering responsiveness.

Therefore, under conditions requiring rapid steering responsiveness, the second partial braking input value DB2 can be used to partially brake one or more of the vehicle's left and right wheels.

As an example, the second partial braking input value DB2 may be applied to the braking system if the steering angle speed SAS′ exceeds a preset threshold steering angle speed SAS′ₜₕᵣₑₛ.

If the steering angle speed SAS′ is less than the preset threshold steering angle speed SAS′ₜₕᵣₑₛ, the second partial braking input value DB2 may not be input to the braking system.

In this case, the second partial braking input value DB2 may be determined to be proportional to the vehicle speed and proportional to a steering angle speed excess value indicating a degree to which the steering angle speed SAS′ exceeds a threshold steering angle speed SAS′ₜₕᵣₑₛ.

As an example, the second partial braking input value DB2 may be determined according to, but is not limited to, the following Equation 4.

DB₂=sgn(S\dot{A}S)×G_{DB1}×W_{V_2}×(|S\dot{A}S|−SASₜₕᵣₑₛ)+bias [Equation 4]

Here, SAS′ or (S\dot{A}S) represents the steering angle speed, G_{DB1} represents a first gain, W_{V_2} represents a second weight proportional to the vehicle speed, and sgn (SAS) represents the sign of the steering angle speed.

Furthermore, (|S\dot{A}S|−S\dot{A}Sₜₕᵣₑₛ) may be a steering angle speed excess value indicating the degree to which the steering angle speed SAS′ exceeds the threshold steering angle speed SAS′ₜₕᵣₑₛ.

In Equation 4, W_{V_2} represents a second weight proportional to the vehicle speed, which may be expressed as in Equation 5 below, but is not limited thereto.

$${W}_{V\_ 2} = 1 - \frac{1}{{G}_{V 2}} ( {V}_{x} - {V}_{s 2} ) \qquad [ Equation 5 ]$$

In Equation 5, Gᵥ₂ may represent a second speed gain value, Vₓ may represent a vehicle speed, and Vₛ₂ may represent a second reference vehicle speed.

As an example, as in Equations 4 and 5, under conditions requiring rapid steering response, the second partial braking input value DB2 provided by the partial braking control module 230 may be determined to be proportional to the vehicle speed and to a steering angle speed excess value indicating the degree to which the steering angle speed SAS′ exceeds a threshold steering angle speed SAS′ₜₕᵣₑₛ.

As another example, the second partial braking input value DB2 may be determined to be proportional only to the steering angle speed excess value and independent of the vehicle speed.

The first partial braking input value DB1 provided to the braking system by the partial braking control module 230 of the open-loop control module 200 may be applied in the case that a greater steering moment is required despite the maximum rear-wheel steering value being applied, i.e., in the case that securing insufficient turning force is required.

Meanwhile, the first partial braking input value DB1 for securing insufficient turning force may be set differently depending on the type of failure of the front-wheel steering system.

The failure of the front-wheel steering system may include a center-locking failure in which the direction of the front-wheels is fixed to the center or a specific position, and a free-rolling failure in which the direction of the front-wheels moves arbitrarily and is not controlled.

The first partial braking input value DB1 may be divided into a third partial braking input value, which is the first partial braking input value when a failure of the front-wheel steering is a center-locking failure, and a fourth partial braking input value, which is the first partial braking input value when a failure of the front-wheel steering system is a free-rolling failure.

In this case, the third and fourth partial braking input values may be different.

For example, the third partial braking input value provided when the front-wheel steering system malfunctions in a center-locking failure may be determined to be inversely proportional to the vehicle speed and proportional to the steering angle excess value, which represents the degree to which the steering angle SAS exceeds the steering angle SASₜₕᵣₑₛ of the steering wheel at the timepoint where the maximum rear-wheel steering angle begins.

For example, the third partial braking input value DB3 may be determined as in Equation 6 below, but is not limited thereto.

$${DB}_{1 - 1} = sgn ( SAS ) \times {G}_{DB 2} \times {W}_{V\_ 1} \times \frac{{DB}_{max}}{{SAS}_{thres}} \times ( \vert SAS \vert - {SAS}_{thres} ) \qquad [ Equation 6 ]$$

In Equation 6, sgn (SAS) represents the sign of the steering angle, G_{DB2} represents the second gain, W_{V_1} represents a first weight inversely proportional to the vehicle speed (see Equation 3), and DBmax represents the maximum partial braking control value.

Additionally, (|SAS|−S\dot{A}Sₜₕᵣₑₛ) may be a steering angle excess value indicating the degree to which the steering angle SAS exceeds the steering angle SASₜₕᵣₑₛ of the steering wheel at the point where the maximum rear-wheel steering angle begins.

As described above, the third partial braking input value DB3, which is provided to compensate for the insufficient turning force by the RWS system in case of the center-locking failure of the front-wheel steering system, may be determined to be inversely proportional to the vehicle speed and proportional to the steering angle excess value, which indicates the degree to which the steering angle SAS exceeds the steering angle SASₜₕᵣₑₛ of the steering wheel at the point where the maximum rear-wheel steering angle begins.

However, this is not limited thereto, and the third partial braking input value DB3 may be determined to be proportional only to the steering angle excess value (|SAS|−SASₜₕᵣₑₛ) and independent of the vehicle speed.

Unlike a center-locking failure of the front-wheel steering system, in the case of a free-rolling failure of the front-wheel steering system, the RWS system alone cannot provide sufficient steering moment. Therefore, a continuous supply of a partial braking input value is required to generate sufficient yaw moment.

Therefore, in the case of a free-rolling failure of the front-wheel steering system, the partial braking control module 230 of the open-loop control module 200 may provide a fourth partial braking input value DB4 that is inversely proportional to the vehicle speed and proportional to the steering angle SAS.

As an example, the fourth partial braking input value DB4 may be determined using, but is not limited to, Equation 7 below.

$${DB}_{1 - 2} = {G}_{DB 3} \times {W}_{V\_ 1} \times \frac{{DB}_{max}}{{SAS}_{thres}} \times SAS \qquad [ Equation 7 ]$$

Here, G_{DB3} represents a third gain, W_{V_1} represents a first weight inversely proportional to vehicle speed (see Equation 2), DBmax represents the maximum partial braking control value, SAS represents the steering angle, and SASₜₕᵣₑₛ represents the steering angle of the steering wheel at the point where the maximum rear-wheel steering angle begins.

However, this is not limited thereto, and the fourth partial braking input value DB4 may be determined proportional only to the steering angle SAS and independent of vehicle speed.

According to the open-loop control module 200 of the steering control device 100 according to the embodiment of the present disclosure, if the failure of the front-wheel steering system is a center-locking failure, the rear-wheel steering control module 220 may provide the rear-wheel steering input value RWS_{INPUT} described above to the RWS system, and the partial braking control module 230 may provide the partial braking input value that is the sum of the third partial braking input value DB3 and the second partial braking input value DB2 described above to the braking system.

In addition, if the failure of the front-wheel steering system is a free-rolling failure, the rear-wheel steering control module 220 may provide the rear-wheel steering input value RWS INPUT described above to the RWS system, and the partial braking control module 230 may provide the partial braking input value, which is the sum of the fourth partial braking input value DB4 and the second partial braking input value DB2, to the braking system.

The open-loop control module 200 of the steering control device 100 according to the embodiment of the present disclosure may further include a tuning module 240.

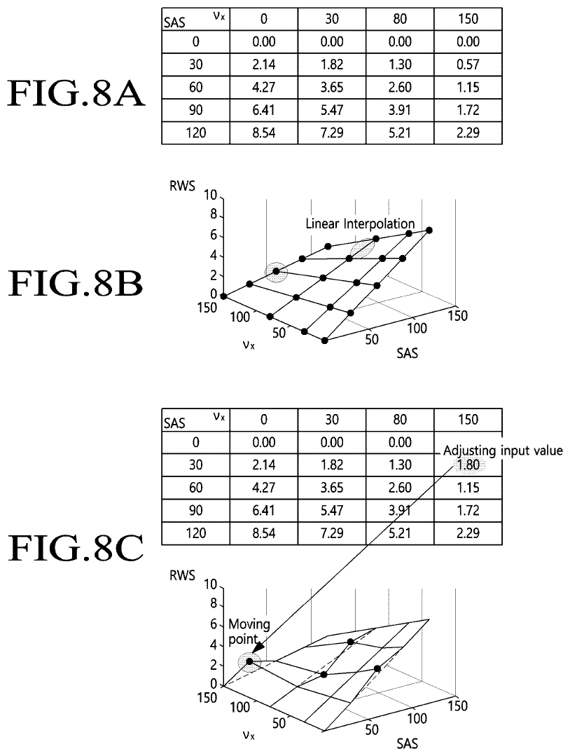

The tuning module 240 may determine a reference rear-wheel steering input value and a reference partial braking input value for a plurality of reference points, and may adjust the reference rear-wheel steering input value or the reference partial braking input value through tuning to determine the rear-wheel steering input value and the partial braking input value, which will be described in more detail below with reference to FIG. 8.

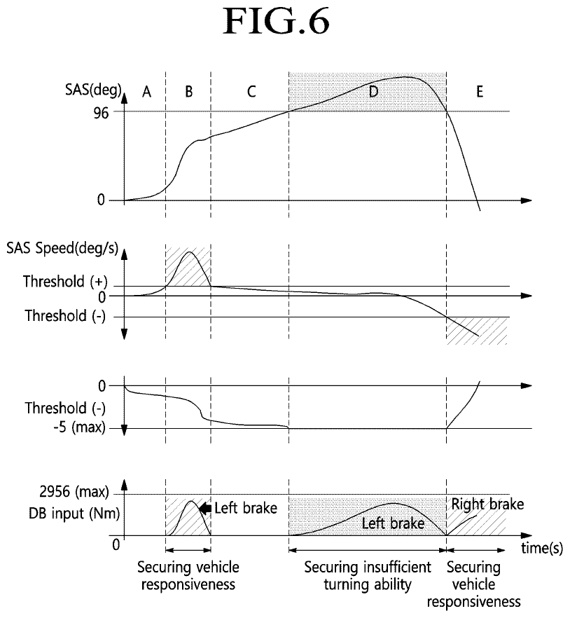

FIG. 6 illustrates an example of a rear-wheel steering input value and a partial braking input value generated by an open-loop control module in the case that the front-wheel steering system has a center-locking failure in an embodiment of the present disclosure.

In FIG. 6, it is assumed that, in the case that the front-wheel steering system is in a center-locking failure state, the steering angle SAS, which is the steering wheel rotation angle due to driver operation, gradually increases from 0 degrees to approximately 120 degrees to the left (i.e., in the positive direction) and then abruptly returns to neutral.

In this case, in section A where the steering angle SAS gradually increases from 0, the rear-wheel control module 220 may provide the aforementioned rear-wheel steering input value RWSINPUT to the RWS system, thereby turning the rear-wheels to approximately −2 degrees.

Subsequently, in section B where the steering angle SAS rapidly increases, the steering angle speed may exceed a certain threshold steering angle speed (Threshold). This section B is an area where the driver has the intention to steer quickly.

Therefore, in section B, the rear-wheel control module 220 of the open-loop control module 200 may provide the rear-wheel steering input value RWS_{INPUT} to the RWS system, and, at the same time, the partial braking control module 230 of the open-loop control module 200 may provide the second partial braking input value DB2 to the braking system to secure steering responsiveness.

That is, in section B, in addition to rear-wheel steering control, partial braking applying a certain amount of braking force only to the left wheel may be further performed to steer the vehicle to the left.

Then, in section C where the steering angle SAS gradually increases again to approximately 96 degrees, the rear-wheel control module 220 may provide the rear-wheel steering input value RWS_{INPUT} to the RWS system to increase the rear-wheel steering angle. In addition, at the end of section C, the rear-wheel steering angle saturates to approximately −5 degrees, which is the maximum rear-wheel steering angle.

That is, in the example of FIG. 5, the steering angle SASₜₕᵣₑₛ of the steering wheel at the point where the maximum rear-wheel steering angle begins may be approximately 96 degrees.

In section C, partial braking control may not be performed.

In section D where the steering angle exceeds 96 degrees and further increases, the rear-wheel steering force is saturated, so it is necessary to secure the insufficient steering force.

Therefore, in the D section, the rear-wheel control module 220 may provide the maximum value of the rear-wheel steering input value RWS_{INPUT} to the RWS system, and at the same time, the partial braking control module 230 may provide the aforementioned partial braking input value to the braking system.

At this time, the partial braking input value applied in the D section may be the aforementioned third partial braking input value DB3.

However, even in the D section, if abrupt steering occurs in which the steering angle speed SAS′ exceeds a preset threshold steering angle speed SAS′ₜₕᵣₑₛ, it is necessary to additionally provide the second partial braking input value DB2.

Therefore, if abrupt steering occurs in section D, the partial braking control module 230 may provide a partial braking input value that is the sum of the third partial braking input value DB3 and the second partial braking input value DB2 to the braking system.

Subsequently, in section E where the steering angle rapidly returns to neutral (i.e., center), the steering angle speed SAS′ may exceed a preset negative threshold steering angle speed SAS′ₜₕᵣₑₛ.

Therefore, in section E, the rear-wheel control module 220 may provide the aforementioned rear-wheel steering input value RWS_{INPUT} to the RWS system to steer the rear-wheels to the right, and at the same time, the partial braking control module 230 may provide the aforementioned second partial braking input value DB2 to the braking system to secure steering responsiveness.

That is, in section E, in addition to rear-wheel steering control, the vehicle can be steered further to the right by performing partial braking that applies a certain amount of braking force only to the right wheel.

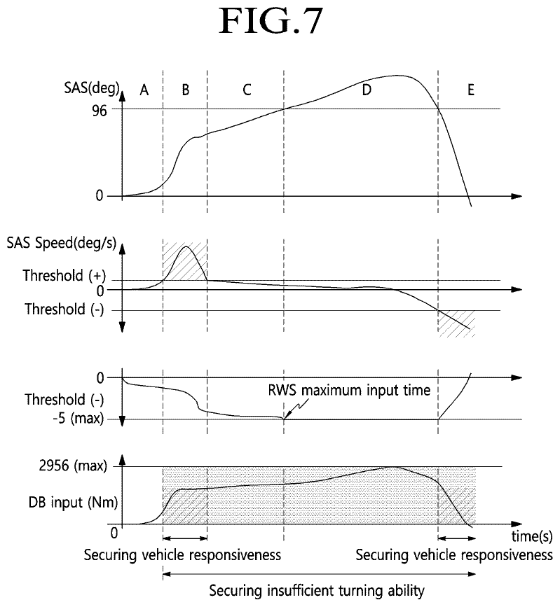

FIG. 7 illustrates an example of rear-wheel steering input value and partial braking input value generated by an open-loop control module in the case that the front-wheel steering system is in a free-rolling failure state, according to an embodiment of the present disclosure.

FIG. 7 illustrates a case where the front-wheel steering system is in a free-rolling failure state.

As in FIG. 6, FIG. 7 also assumes a situation where the steering angle SAS, which is the steering wheel rotation angle due to driver operation, gradually increases from 0 degrees to approximately 120 degrees to the left (i.e., in the positive direction) and then abruptly returns to neutral.

In this case, in section A where the steering angle SAS gradually increases from 0, the rear-wheel control module 220 may provide the aforementioned rear-wheel steering input value RWS_{INPUT} to the RWS system, thereby turning the rear-wheels to approximately −2 degrees.

In the case that the front-wheel steering system is in a free-rolling failure state, if the rear-wheels are steered by the RWS, the front-wheels may be steered in the opposite direction depending on the size and sign of the scrub radius.

Specifically, in the case where the front-wheel steering system is in a free-rolling fail state, if the scrub radius has a negative value, the front-wheels may be steered in the opposite direction to the steering direction of the rear-wheels.

Therefore, unlike the case of center-locking failure, if the front-wheel steering system is in free-rolling failure, it is difficult to generate sufficient steering moment in the vehicle with the RWS control input value, so it is required to continuously apply a partial braking input to generate sufficient yaw moment.

Therefore, if the front-wheel steering system has a free-rolling failure, the rear-wheel control module 220 of the open-loop control module 200 may provide the rear-wheel steering input value RWS_{INPUT} to the RWS system throughout the entire section in which the steering angle SAS changes, and at the same time, the partial braking control module 230 may continuously provide the aforementioned partial braking input value to the braking system.

At this time, the application pattern of the rear-wheel steering input value RWS_{INPUT} may be the same as in FIG. 6, but the partial braking input value may be provided in a different pattern from FIG. 6.

As an example, in the case where the front-wheel steering system is in a free-rolling failure state, the partial braking control module 230 of the open-loop control module 200 may continuously provide the aforementioned fourth partial braking input value to the braking system, and may additionally apply the second partial braking input value in a section where rapid steering response is required.

Specifically, in section B where the steering angle rapidly increases, the rear-wheel control module 220 of the open-loop control module 200 may provide the rear-wheel steering input value RWS_{INPUT} to the RWS system, and at the same time, the partial braking control module 230 may provide the partial braking input value, which is the sum of the fourth partial braking input value DB4 and the second partial braking input value DB2, to the braking system to secure steering responsiveness.

Subsequently, in sections C and D where the steering angle SAS gradually increases again, the rear-wheel control module 220 may provide the rear-wheel steering input value RWS_{INPUT} to the RWS system, and at the same time, the partial braking control module 230 may provide only the fourth partial braking input value DB4 to the braking system.

Then, in the E section where the steering angle rapidly returns to neutral (i.e., center), the steering angle speed SAS′ may exceed the preset negative threshold steering angle speed SAS′ₜₕᵣₑₛ.

Therefore, in the E section, the rear-wheel control module 220 may input the rear-wheel steering input value RWS_{INPUT} to the RWS system to steer the rear-wheels to the right. In addition, at the same time, in order to secure steering responsiveness, the partial braking control module 230 may input a partial braking input value that is the sum of the fourth partial braking input value DB4 and the second partial braking input value DB2 to the braking system.

As described above, by using the open-loop control module 200 of the steering control device 100 according to the embodiment of the present disclosure, the steering stability of the vehicle can be maintained by optimally controlling the RWS system and the partial braking system in a feedforward manner depending on the type of failure of the front-wheel steering system.

FIG. 8 illustrates an example of a tuning process of a tuning module included in the open-loop control module of the steering control device according to the embodiment of the present disclosure.

The open-loop control module 200 of the steering control device 100 according to the embodiment of the present disclosure may be equipped with a tuning function to optimally maintain the rear-wheel steering input value and the partial braking input value DB.

To this end, the tuning module 240 may determine a reference rear-wheel steering input value and a reference partial braking input value for a plurality of reference points, and adjust or tune the reference rear-wheel steering input value or the reference partial braking input value to determine the rear-wheel steering input value and the partial braking input value.

In this case, the reference point or the braking point may be a point defined by a set of (vehicle speed, steering angle, or steering angle speed).

The tuning module 240 may map the reference rear-wheel steering input value and the reference partial braking input value, or the rear-wheel steering input value and the partial braking input value, for a plurality of reference points to a three-dimensional space, and interpolate information between the plurality of reference points to generate a three-dimensional map.

Referring to FIG. 8, the tuning module 240 of the open-loop control module 200 is described as follows.

As in the example of FIG. 8, the tuning module 240 of the open-loop control module 200 may set a total of 20 reference points composed of a combination of four vehicle speed values (e.g., 0, 30, 80, 150 km/h) and five steering angles (e.g., 0, 30, 60, 90, 120 degrees). (Brake Point Selection)

Next, the tuning module 240 may determine the reference rear-wheel steering input value and the reference partial braking input value for each reference point based on the Equations 2 to 6, and may generate table-type data, as shown in (a) of FIG. 8.

Furthermore, as illustrated in (b) of FIG. 8, the tuning module 240 may generate a 3D map of the reference rear-wheel steering input value (e.g., RWS) and the reference partial braking input values (e.g., DB1 and DB2) for each reference point. (Initial 3D Map Creation)

In this case, the tuning module 240 may interpolate information between multiple reference points to generate a 3D map.

In addition, as illustrated in (b) of FIG. 8, the tuning module 240 may adjust or tune the reference rear-wheel steering input value or the reference partial braking input value through actual experiments or simulations to determine the final rear-wheel steering input value and the final partial braking input value.

In this case, the tuning module 240 may modify the initial 3D map to reflect the tuned final rear-wheel steering input value and the final partial braking input value, thereby generating the final 3D map.

FIG. 9 is a configuration diagram of a closed-loop control module 300 according to an embodiment of the present disclosure.

Referring to FIG. 3, the closed-loop control module 300 of the steering control device 100 may include a sensor unit 310 that acquires information about the vehicle, and a closed-loop control unit 320 that generates a target yaw rate according to a target steering angle based on information acquired from the sensor unit when a failure of the SbW system is determined, and generates and outputs a partial braking control signal and a rear-wheel steering control signal so that the measured yaw rate follows the target yaw rate.

To this end, the closed-loop control unit 320 may determine the partial braking control signal and the rear-wheel steering control signal so that the measured yaw rate follows the target yaw rate by using a feedback control method such as PID control, optimal control, and model predictive control.

The sensor unit 310 may include various sensors that acquire information about the vehicle and information about the exterior of the vehicle.

According to one example, the sensor unit 310 may include one or more sensors that detect information about the vehicle, such as a steering angle sensor that detects information about the rotation angle of the steering wheel of the vehicle, a steering angle speed sensor that detects the steering angle speed of the steering wheel, a rack position sensor that detects information about the position of the rack, a motor torque sensor that detects the torque of the motor within the steering system, and a current sensor that detects current within the steering system. In addition, the sensor unit 310 may further include various image sensors or range sensors, such as a camera, lidar, or radar sensor, for detecting other vehicles or lanes outside the vehicle.

However, the sensor unit 310 may not be included within the steering control device 100 or the closed-loop control module 300 according to an embodiment of the present disclosure, but may be positioned at a certain location on the vehicle outside thereof.

The closed-loop control unit 320 may control the overall operation of the closed-loop control module 300.

According to one example, the closed-loop control unit 320 may be implemented as a dedicated ECU, MCU, DCU, etc. Alternatively, the closed-loop control unit 320 may be implemented as an SbB ECU of an SbB system that performs embodiments according to the present disclosure.

In this case, the SbB ECU may be communicatively connected to a device necessary for performing embodiments according to the present disclosure, such as a sensor unit, a front-wheel steering system, a steering control device, a rear-wheel steering system, and a braking system. The closed-loop control unit 320 may perform embodiments according to the present disclosure through integrated control of devices such as the sensor unit, the steering system, the rear-wheel steering control system, and the braking system.

According to an embodiment, if the closed-loop control unit 320 is implemented as a dedicated device, the closed-loop control unit 320 may be set to a standby mode or a dormant mode under normal conditions. If a failure of the front-wheel steering system occurs and an activation signal or trigger signal according to the control method selection module 400 is received, the closed-loop control unit 320 may switch to an operating mode and may perform a steering control operation according to the present disclosure.

The closed-loop control unit 320 may check for a failure of the front-wheel steering system (e.g., a steer-by-wire steering system). For example, information regarding the occurrence of a failure, such as a communication failure within the SbW steering system, may be acquired from a separate device and transmitted to the closed-loop control unit 320. Alternatively, the closed-loop control unit 320 may directly determine whether a failure of the steering system has occurred based on a signal output from the sensor unit 110 or signals transmitted and received within the steering system.

Referring to FIG. 4, the closed-loop control unit 320 may include a target yaw rate generation module 321 that generates target yaw rate according to a target steering angle based on information acquired from a sensor unit, a partial braking control module 322 that generates a partial braking control signal to follow the target yaw rate and outputs the partial braking control signal to the braking system, and a rear-wheel steering control module 323 that generates a rear-wheel steering control signal and outputs the rear-wheel steering control signal to the rear-wheel steering (RWS) system. According to an example, each module may be implemented in hardware or software or a combination thereof.

If it is determined that a failure has occurred in the front-wheel steering system, the closed-loop control unit 320 may generate a target yaw rate based on a steering angle corresponding to a target direction in order to control the steering to the target direction.

For example, the closed-loop control unit 320 may receive rotation angle information of a steering wheel from a steering angle sensor installed in the vehicle.

The closed-loop control unit 320 may generate a target yaw rate based on the rotation angle information of a steering wheel (i.e., steering angle information).

Specifically, if a failure, such as a communication failure in the steering system, prevents the driver's steering wheel manipulation from being reflected in the steering control, the closed-loop control unit 320 may determine the steering angle information, i.e., the steering wheel rotation angle information obtained from the steering angle sensor, as the target steering information. Accordingly, the closed-loop control unit 320 may generate a yaw rate value corresponding to the steering angle information.

For example, the closed-loop control unit 320 may set a plurality of sections for the steering wheel rotation angle and set different sensitivities for each section to generate a target yaw rate.

That is, the closed-loop control unit 320 may divide the steering wheel's rotational range into a plurality of sections based on predetermined criteria and set lower sensitivities for sections with larger rotation angles.

Furthermore, the closed-loop control unit 320 may set different sensitivity information depending on the vehicle speed. For example, the sensitivity may be set lower for faster vehicle speeds than for slower vehicle speeds. Furthermore, according to another example, such sensitivity information for each rotation angle relative to vehicle speed may be preset and stored in a lookup table.

In this case, the closed-loop control unit 320 may generate a target yaw rate by reflecting the sensitivity set for each section of the steering angle.

For example, the sensitivity may be set to 1 for a range of 10 degrees or less in a clockwise or counterclockwise direction, based on 0 degrees. Furthermore, the sensitivity may be set to 0.8 for a range exceeding 10 degrees and up to 40 degrees. Furthermore, the sensitivity may be set to 0.5 for a range exceeding 40 degrees.

Therefore, if the steering wheel rotation angle is 5 degrees, the corresponding rotation angle information may be used as is. However, if the steering wheel rotation angle is 20 degrees, 18 degrees, corresponding to (10*1)+(10*0.8), may be used as the rotation angle. However, this is merely an example and is not limited thereto. The steering wheel rotation angle range and sensitivity may be set differently as needed. This can prevent abrupt steering control if the driver turns the steering wheel beyond the target steering angle in the event of a steering system failure.

According to another example, the closed-loop control unit 320 may receive information about a driving path along which the vehicle is traveling and information about other vehicles around the vehicle from the sensor unit. The closed-loop control unit 320 may generate a target yaw rate based on the information about the driving path and the information about other vehicles. That is, if a failure, such as a communication failure in the steering system, prevents the driver's steering wheel operation from being reflected in the steering control, the closed-loop control unit 320 may determine a target steering direction that reflects the curvature information of the driving lane or the driving information of other vehicles, and generate a yaw rate value accordingly.

For example, if a left-curving driving lane is detected in case of the occurrence of a failure, the closed-loop control unit 320 may generate a target yaw rate based on the curvature of the driving lane. Furthermore, if another vehicle enters the driving lane of the vehicle in case of the occurrence of a failure, the target yaw rate may be generated in a direction to avoid the other vehicle. Additionally, if a shoulder or safety zone is detected outside the driving lane, the closed-loop control unit 320 may generate a target yaw rate for steering toward the corresponding shoulder or safety zone.

Furthermore, according to an example, the closed-loop control unit 320 may generate a target yaw rate by reflecting all of the steering angle information, information about the driving path, and information about other vehicles around the vehicle. In this case, the closed-loop control unit 320 may set priorities for each of the steering angle information, information about the driving path, and information about other vehicles around the vehicle, and generate a target yaw rate according to the priorities. For example, even if it is detected that the driver turns the steering wheel clockwise, if the driving lane is detected to be turning to the left, the closed-loop control unit 320 may give priority to the information about the driving path and generate a target yaw rate.

In this way, if the target yaw rate is generated, the closed-loop control unit 320 may generate and output a partial braking control signal and a rear-wheel steering control signal to follow or track the target yaw rate, which will be described in detail below with reference to the relevant drawings.

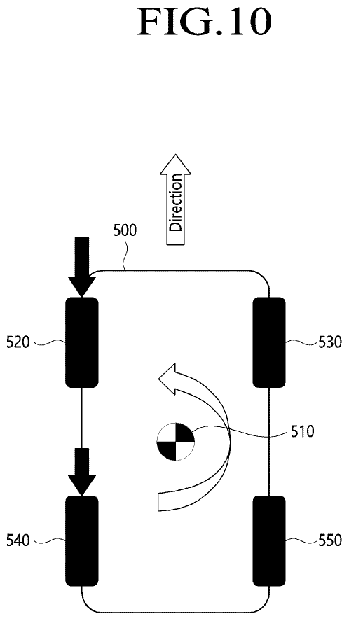

FIGS. 10 to 12 are diagrams for explaining a process in which a closed-loop control module according to an embodiment of the present disclosure performs rear-wheel steering control after partial braking control.

According to an example, the closed-loop control unit 320 of the closed-loop control module 300 may generate a partial braking control signal to track the target yaw rate and output the partial braking control signal to the braking system, and generate a rear-wheel steering control signal to compensate for a front-wheel steering angle generated by a scrub radius of the vehicle during partial braking by the partial braking control signal and output the rear-wheel steering control signal to the rear-wheel steering (RWS) system.

The closed-loop control unit 320 may control the steering of the vehicle by outputting a partial braking control signal to the braking system.

That is, since the partial braking generates a difference in left-right longitudinal force in a moving vehicle, the closed-loop control unit 320 may control the steering using the yaw moment and lateral force generated according to the difference in left-right longitudinal force.

Referring to FIG. 10, if a target yaw rate is generated to the left according to the rotation of the steering wheel 510, braking force may be applied to the left wheels 520 and 540 to follow the target yaw rate.

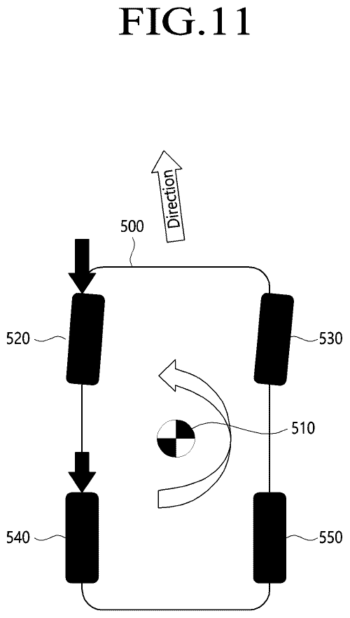

As an example, the scrub radius of the vehicle may be set to have a negative value. This is to secure the vehicle's straight-line stability by utilizing the wheel angle generated in the opposite direction of the vehicle's yaw behavior when partial braking force is applied. However, when a negative scrub radius is set in this manner, the wheel angle of the front-wheels 520 and 530 (hereinafter referred to as the “front-wheel steering angle”) may be generated to the right, opposite to the yaw behavior, as illustrated in FIG. 11. In this case, the yaw moment and lateral movement generated by partial braking may be canceled, thereby reducing the performance and efficiency of partial braking control, which replaces steering operation.

Accordingly, the closed-loop control unit 320 may generate a rear-wheel steering control signal for the rear-wheels 540 and 550 to cancel the impact of the front-wheel steering angle generated in the opposite direction of the target moment, and output the signal to the rear-wheel steering system. That is, the moment generated by the partial braking (i.e., SbB) may be assisted by using the rear-wheel steering control capable of compensating for the influence according to the wheel e front-wheel. Accordingly, the closed-loop control unit 320 may perform an operation to generate a steering angle identical to the target direction by integrating the rear-wheel steering control into the partial braking function.

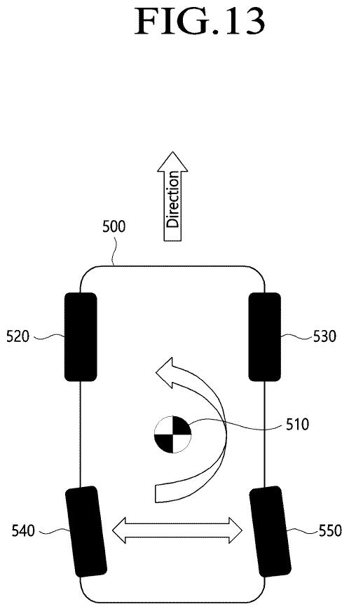

FIGS. 13 to 15 illustrate a closed-loop control module according to an embodiment of the present disclosure performing partial braking control after rear-wheel steering control.

According to another example, the closed-loop control unit 320 may generate a rear-wheel steering control signal based on a target yaw rate and output the rear-wheel steering control signal to the rear-wheel steering system, and generate a partial braking control signal for tracking the target yaw rate and output the partial braking control signal to the braking system. In this case, the closed-loop control unit 320 may generate and output a rear-wheel steering control signal to the rear-wheel steering system for a predetermined period of time, and after the predetermined period of time, generate and output a partial braking control signal to the braking system.

The closed-loop control unit 320 may generate a rear-wheel steering control signal and output the rear-wheel steering control signal to the rear-wheel steering system to perform steering corresponding to the target yaw rate. Referring to FIG. 13, if a target yaw rate is generated to the left according to the rotation of the steering wheel 510, the closed-loop control unit 320 may perform rear-wheel steering control to rotate the rear-wheels 540 and 550 to the left to follow the target yaw rate.

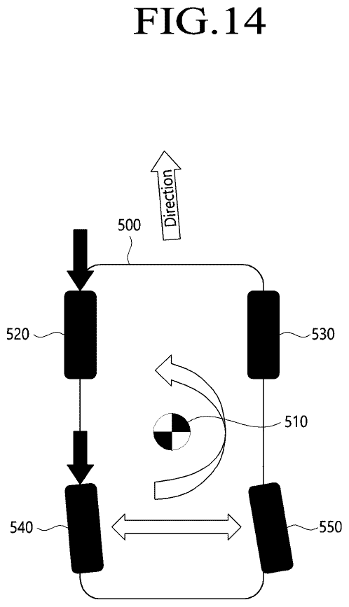

According to an example, rear-wheel steering control according to the target yaw rate may be preferentially performed for a predetermined period of time to generate a steering motion corresponding to the target yaw rate. That is, as illustrated in FIG. 14, the vehicle's direction of travel may be changed through rear-wheel steering control. Thereafter, the closed-loop control unit 320 may generate a partial braking control signal to track the target yaw rate and apply braking force to the left wheels 520 and 540.

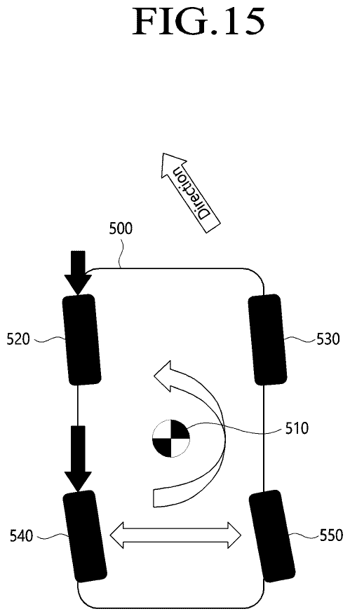

Even in this case, as described above, the wheel angle of the front-wheels 520 and 530 may be generated to the right, which is opposite to the yaw behavior, due to the negative scrub radius. However, since rear-wheel steering control is performed in advance before performing the partial braking, the front-wheel steering angle may be canceled. Accordingly, as illustrated in FIG. 15, the front-wheels 520 and 530 may be rotated at a gentler angle than the rear-wheels 540 and 550. In this way, since the front-wheels 520 and 530 and the rear-wheels 540 and 550 are arranged in the same direction, the vehicle can be steered with a larger turning radius.

That is, the closed-loop control unit 320 may first perform the rear-wheel steering (RWS) control operation for a short period of time before the SbB control based on the partial braking, thereby generating a steering motion, and then perform the SbB control with a time difference to generate a steering angle equal to the target moment, thereby assisting in creating a larger and smoother steering motion.

Accordingly, in the event of a front-wheel steering system failure in a vehicle equipped with the SbW system and the RWS system, a safe steering control device and method can be provided without a separate mechanical additional design by performing the target steering using partial braking and rear-wheel steering control. In addition, by compensating for the impact of the negative scrub radius during partial braking through rear-wheel steering control, the negative scrub radius designed to secure vehicle stability can be maintained while ensuring redundancy for the steering system and driver safety.

As described above, the steering control device according to the embodiment of the present disclosure may secure the vehicle stability in the event of a front-wheel steering system failure by selectively performing open-loop control and closed-loop control for the rear-wheel steering system and the partial braking system according to the vehicle behavior state determined based on yaw rate information.

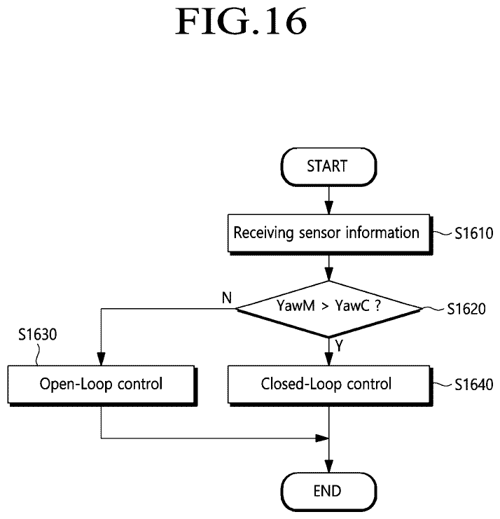

FIG. 16 is a flowchart illustrating a steering control method according to an embodiment of the present disclosure.

The steering control method according to an embodiment of the present disclosure may be performed in a vehicle equipped with a rear-wheel steering (RWS) system and a braking system.

In addition, the steering control method according to an embodiment of the present disclosure may be performed by the steering control device described based on FIGS. 1 to 15.

As an example, a steering control method according to an embodiment of the present disclosure may include an information receiving step (S1610), a control method selection step (S1620), and an open-loop control step (S1630) or closed-loop control step (S1640) that are optionally performed.

In the information receiving step (S1610), a plurality of vehicle information used in the embodiment of the present disclosure may be received from a sensor unit equipped in the vehicle.

In this case, the vehicle information may include, but is not limited to, information such as a yaw rate, a steering angle, a vehicle speed, and a steering angle speed.

In the control method selection step (S1620), a measured yaw rate YawM obtained from the received information may be compared with a preset reference yaw rate YawC, and one or more control methods of the rear-wheel steering system and the braking system may be determined based on the comparison result.

Specifically, the control method selection step (S1620) may include selecting an open-loop control method if the measured yaw rate is less than or equal to the reference yaw rate, and selecting a closed-loop control method if the measured yaw rate is greater than the reference yaw rate.

The open-loop control step (S1630) may be selected and performed by the control method selection step in the case that the measured yaw rate is less than or equal to the reference yaw rate.

In the open-loop control step (S1630), the open-loop control module 200 may control one or more of the rear-wheel steering system and the braking system in a feed-forward manner based on a control input value determined based on one or more of the steering angle, vehicle speed, and steering angle speed.

The closed-loop control step (S1640) may be selected and performed by the control method selection step in the case that the measured yaw rate is greater than the reference yaw rate.

Specifically, in the closed-loop control step (S1640), the closed-loop control module 300 may determine a target yaw rate based on information acquired from the sensor unit, and generate control signals to follow the target yaw rate, thereby controlling at least one of the rear-wheel steering system and the braking system in a feedback manner.

In the open-loop control step (S1630), the open-loop control module 200 may determine a rear-wheel steering input value and a partial braking input value through open-loop control and supply the rear-wheel steering input value and the partial braking input value to the rear-wheel steering system and the braking system, respectively.

In the closed-loop control step (S1640), the closed-loop control module 300 may supply a rear-wheel steering control signal and a partial braking control signal through closed-loop control to the rear-wheel steering system and the braking system.

Meanwhile, the vehicle may further include a steer-by-wire (SbW) system as a front-wheel steering system, and the steering control method according to the embodiment of the present disclosure may be performed only if a failure occurs in the SbW system.

Meanwhile, the reference yaw rate may be determined by a lateral dynamic model of the vehicle.

As an example, the open-loop control step (S1630) may include a rear-wheel steering control step (S1632) that determines a rear-wheel steering input value based on a steering angle and a vehicle speed and provides the determined rear-wheel steering input value to the RWS system, and a partial braking control step (S1634) that determines a partial braking input value based on a steering angle or steering angle speed and a vehicle speed and provides the determined partial braking input value to the braking system.

In this case, the rear-wheel steering input value may be determined to be proportional to the steering angle and inversely proportional to the vehicle speed.

In addition, the partial braking input value may include a first partial braking input value to compensate for a lack of steering force due to the rear-wheel steering input value, and a second partial braking input value to ensure vehicle responsiveness if the steering angle speed exceeds a threshold steering angle speed.

In this case, the second partial braking input value for ensuring vehicle responsiveness may be determined to be proportional to the vehicle speed and proportional to a steering angle speed excess value indicating a degree to which the steering angle speed exceeds a threshold steering angle speed.

In addition, the first partial braking input value for compensating for a lack of steering force may include a third partial braking input value if the failure of the SbW system is a center-locking fail, and a fourth partial braking input value if the failure of the SbW system is a free-rolling fail. In this case, the third partial braking input value and the fourth partial braking input value may be determined differently.

Specifically, the third partial braking input value may be determined to be inversely proportional to the vehicle speed and proportional to a steering angle excess value indicating a degree to which the steering angle exceeds the steering angle of the steering wheel at the point where the maximum rear-wheel steering angle begins.

The fourth partial braking input value may be determined to be inversely proportional to the vehicle speed and proportional to the steering angle.

Meanwhile, the closed-loop control step (S1640) may include, as an example, a step of generating a rear-wheel steering control signal based on a target yaw rate and outputting the rear-wheel steering control signal to the rear-wheel steering system, and generating a partial braking control signal for tracking the target yaw rate and outputting the partial braking control signal to the braking system.

In this case, the closed-loop control step (S1640) may include a step of generating and outputting the rear-wheel steering control signal to the rear-wheel steering system for a predetermined period of time, and generating and outputting the partial braking control signal to the braking system after the predetermined period of time.

In addition, the closed-loop control step (S1640) may include a step of setting a plurality of sections for the steering angle and setting different sensitivities for each section to determine the target yaw rate.

As another example, in the closed-loop control step (S1640), the closed-loop control module 300 may generate a partial braking control signal for tracking the target yaw rate and output the partial braking control signal to the braking system, and generate a rear-wheel steering control signal for compensating for a front-wheel steering angle generated by a scrub radius of the vehicle during partial braking by the partial braking control signal and output the rear-wheel steering control signal to the RWS system.

The steering control device 100 according to the present embodiment described above and the control method selection module 400, open-loop control module 200, and closed-loop control module 300 included therein may be implemented as a separate ECU or a DCU, which is an integrated ECU that handles various controls of a vehicle, but is not limited thereto, and may be implemented in one or more of an SbW ECU for front-wheel steering, an RWS ECU for rear-wheel steering, and a brake ECU for braking control.

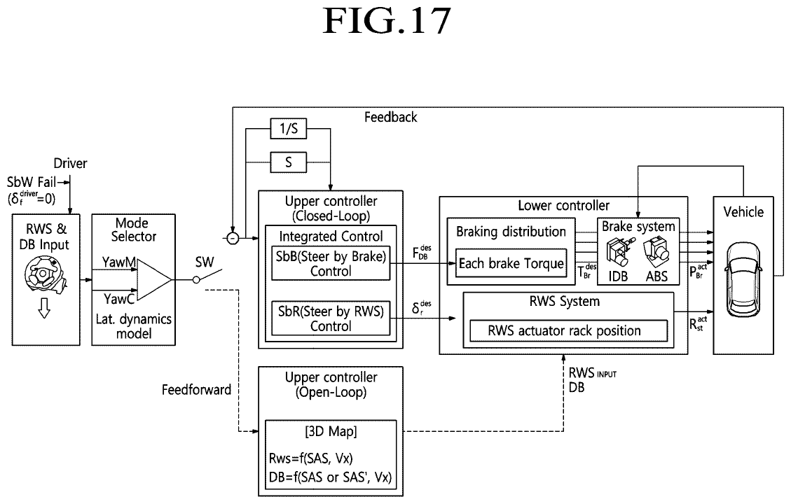

FIG. 17 is a control block diagram for explaining the overall operation of a steering control system according to an embodiment of the present disclosure.

The steering control system according to an embodiment of the present disclosure may include a mode selector and a switch for selecting a control method.

In addition, the steering control system according to an embodiment of the present disclosure may include an upper controller as a closed-loop control module according to an embodiment of the present disclosure, and an upper controller as an open-loop control module according to an embodiment of the present disclosure.

The upper controller may generate several control input values (e.g., values of open-loop control module) or control signals (e.g., signals of closed-loop control module) according to an embodiment of the present disclosure and provide the input values and the control signals to a lower controller.

The lower controller may include a rear-wheel steering (RWS) system, a braking distribution system (BD), and a braking system.

First, if a failure of the front-wheel steering system (SbW) is detected, the mode selector may compare the measured yaw rate YawM measured by the sensor with a preset reference yaw rate YawC.

If the measured yaw rate YawM is greater than the reference yaw rate YawC, a switch (SW) included in the control method selection module may select the upper controller corresponding to the closed-loop control module.

Accordingly, the upper controller corresponding to the closed-loop control module may determine the target yaw rate based on the steering angle, as described above, and perform feedback control so that the yaw rate measured by the vehicle tracks the target yaw rate.

FIG. 17 illustrates a PID that performs proportional control (P), integral control(S), and differential control (1/S) for feedback control. However, this is not limited thereto, and feedback methods such as optimal control and model predictive control can be used.

The upper controller, which corresponds to the closed-loop control module, may determine the rear-wheel steering control signal

$$( {δ}_{r}^{des} )$$

and the partial braking control signal

$$( {F}_{DB}^{des} )$$

and supplies the control signals to the lower controllers which are the rear-wheel steering system and the brake distributor.

The braking system as the lower controller may supply a braking signal

$$( {P}_{Br}^{act} )$$

for controlling each left and right wheel to the respective brake devices, and the rear-wheel steering system may output a command signal

$$( {R}_{st}^{act} )$$

for the rear-wheel steering motor to the rear-wheel steering motor.

Meanwhile, if the measured yaw rate YawM is less than the reference yaw rate YawC according to the comparison result of mode selector, a switch (SW) included in the control method selection module may select the lower controller, which corresponds to the open control module.

Accordingly, the upper controller corresponding to the open-loop control module may determine the rear-wheel steering input value RWS_{INPUT} and partial braking input value DB, which are predetermined based on the steering angle, vehicle speed, and steering angle speed, from the map or table, and transmit the input values to the lower controller, as described above.

That is, the upper controller corresponding to the open-loop control module may control the lower controller using a feedforward method.

Based on the transmitted rear-wheel steering input value RWS_{INPUT} and partial braking input value DB, the braking system as the lower controller may supply a braking signal

$$( {P}_{Br}^{act} )$$

to the braking devices of each wheel for controlling each of the left and right wheels, and the rear-wheel steering system may output a command signal

$$( {R}_{st}^{act} )$$

to the rear-wheel steering motor.

In such a steering control system, in order to compensate for errors caused by external factors such as road surface friction and slope, a compensation partial braking value may be further reflected during feedback control to determine the final partial braking control signal.

Additionally, for safety reasons, if wheel slip occurs during control, ABS and ESC logic within the braking system may be further performed.

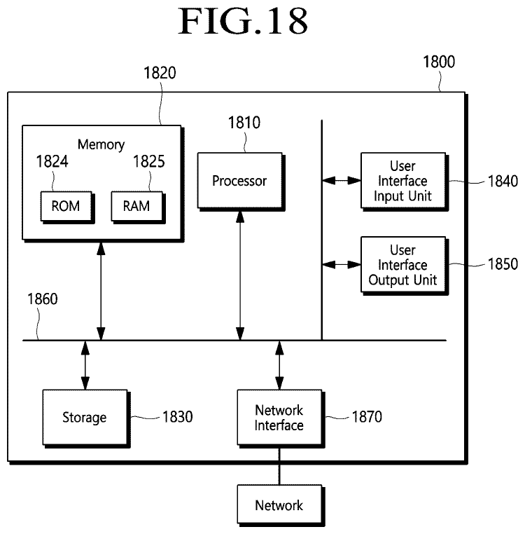

FIG. 18 illustrates an example of the hardware configuration of a steering control device according to an embodiment of the present disclosure.

Referring to FIG. 18, the steering control device 100 according to the above-described embodiments, and the open-loop control module 200, closed-loop control module 300, and control method selection module 400 included therein, may be implemented as specific hardware or software implemented within a computer system.

That is, the steering control device 100 described above, and the open-loop control module 200, closed-loop control module 300, and control method selection module 400 included therein may be implemented as a computer device having hardware as shown in FIG. 18.

As illustrated in FIG. 18, the computer system 1800, which is an implementation form of the steering control device 100 according to the present embodiment, and the open-loop control module 200, closed-loop control module 300, and control method selection module 400 included therein, may include at least one or more elements from among one or more processors 1810, a memory 1820, a storage 1830, a user interface input unit 1840, and a user interface output unit 1850, which may communicate with each other via a bus 1860.

Additionally, the computer system 1800 may also include a network interface 1870 for connecting to a network. The processor 1810 may be a CPU or semiconductor device that executes processing instructions stored in the memory 1820 and/or storage 1830.

The memory 1820 and storage 1830 may include various types of volatile/non-volatile storage media. For example, the memory may include a ROM 1821 and a RAM 1823.

Additionally, the computer system 1800 used in this embodiment may include software modules for performing the functions of the open-loop control module 200, the closed-loop control module 300, and the control method selection module 400 that constitute the steering control device according to this embodiment.

Specifically, a software module for selecting either an open-loop control module or a closed-loop control module by comparing the measured yaw rate with a reference yaw rate in the event of a front-wheel system failure, a software module for determining and supplying preset rear-wheel steering input values and partial braking input values based on a steering angle and vehicle speed for open-loop control, and a software module for determining and outputting rear-wheel steering control signals and partial braking control signals as feedback signals so that the vehicle yaw rate tracks the target yaw rate, may be installed in the computer system 1800.

The processor (MCU; 1810) of the steering control device according to the present embodiment may execute the aforementioned software module stored in the storage 1830 or memory 1820 to perform the corresponding function.

The above-described present disclosure may be implemented as computer-readable code on a program-recorded medium. The computer-readable medium includes any type of recording device storing data that can be read by a computer system. Examples of computer-readable media include hard disk drives (HDDs), solid state disks (SSDs), silicon disk drives (SDDs), ROMS, RAMS, CD-ROMS, magnetic tapes, floppy disks, optical data storage devices, and the like, and also include those implemented in the form of carrier waves (e.g., transmission via the Internet).

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A steering control device for a vehicle comprising a rear-wheel steering system and a brake system, the steering control device comprising:
an open-loop control module configured to control at least one of the rear-wheel steering system or the brake system in a feed-forward manner based on at least one of a steering angle of a steering wheel, a vehicle speed, and a steering angle speed of the steering wheel measured by one or more sensors;
a closed-loop control module configured to determine a target yaw rate based on information acquired from the one or more sensors, and control at least one of the rear-wheel steering system or the brake system to cause the vehicle to follow the target yaw rate in a feedback manner; and
one or more processors configured to selectively operate the open-loop control module or the closed-loop control module based on a comparison between a measured yaw rate detected by the one or more sensors and a reference yaw rate.

2. The steering control device of claim 1, wherein the one or more processors are configured to, if the measured yaw rate is greater than the reference yaw rate, activate the closed-loop control module.

3. The steering control device of claim 1, wherein:
the vehicle further includes a steer-by-wire system associated with front wheels included in vehicle wheels, and
the steering control device is configured to operate when the steer-by-wire system fails.

4. The steering control device of claim 1, wherein the reference yaw rate is determined according to a lateral dynamic model of the vehicle.

5. The steering control device of claim 3, wherein the open-loop control module is configured to:
determine a rear-wheel steering input value for controlling steering of rear wheels included in the vehicle wheels based on the steering angle of the steering wheel and the vehicle speed and output the rear-wheel steering input value to the rear-wheel steering system; and
determine a partial braking input value for partially braking one or more of the vehicle wheels to steer the vehicle based on the steering angle or the steering angle speed of the steering wheel measured by the one or more sensors, and the vehicle speed, and output the partial braking input value to the brake system to steer the vehicle by partially braking one or more of the vehicle wheels.

6. The steering control device of claim 5, wherein the open-loop control module is configured to determine the rear-wheel steering input value to be proportional to the steering angle of the steering wheel and inversely proportional to the vehicle speed.

7. The steering control device of claim 6, wherein:
the partial braking input value includes a first partial braking input value for compensating for a lack of steering force in association with the rear-wheel steering input value, and
the open-loop control module is configured to, when the steering angle speed of the steering wheel exceeds a threshold steering angle speed, include a second partial braking input value for vehicle responsiveness in the parking braking input value.

8. The steering control device of claim 7, wherein the open-loop control module is configured to determine the second partial braking input value to be proportional to the vehicle speed and a steering angle speed excess value indicative of a degree by which the steering angle speed of the steering wheel exceeds the threshold steering angle speed.

9. The steering control device of claim 8, wherein the open-loop control module is configured to differently determine the first partial braking input value depending on whether the steer-by-wire system has a center-locking failure or a free-rolling failure.

10. The steering control device of claim 9, wherein the open-loop control module is configured to, when the steer-by-wire system has the center-locking failure, determine the first partial braking input value to be inversely proportional to the vehicle speed and proportional to a steering angle excess value indicative of a degree by which the steering angle of the steering angle exceeds a steering angle of a steering wheel at a point where a maximum rear-wheel steering angle begins.

11. The steering control device of claim 9, wherein the open-loop control module is configured to, when the steer-by-wire system has the free-rolling failure, determine the first partial braking input value to be inversely proportional to the vehicle speed and proportional to the steering angle of the steering angle.

12. The steering control device of claim 3, wherein the closed-loop control module is configured to:
generate a rear-wheel steering control signal based on the target yaw rate and output the rear-wheel steering control signal to the rear-wheel steering system; and
generate a partial braking control signal for causing the vehicle to follow the target yaw rate and output the partial braking control signal to the brake system.

13. The steering control device of claim 3, wherein the closed-loop control module is configured to:
output, to the brake system, a partial braking control signal for causing the vehicle to track the target yaw rate, and
output, to the rear-wheel steering system, a rear-wheel steering control signal for compensating for a steering angle of the front wheels caused by a scrub radius of the vehicle during partial braking performed in response to the partial braking control signal.

14. The steering control device of claim 12, wherein the closed-loop control module is configured to:
output the rear-wheel steering control signal to the rear-wheel steering system for a predetermined period of time; and after the predetermined period of time, output the partial braking control signal to the brake system.

15. The steering control device of claim 3, wherein the closed-loop control module is configured to:
determine the target yaw rate based on the steering angle of the steering wheel, and
set a plurality of sections for the steering angle of the steering wheel and set different sensitivities for each of the plurality of sections to determine the target yaw rate.

16. A steering control method for a vehicle comprising a rear-wheel steering system and a brake system, the steering control method comprising:
selecting, among an open-loop control and a closed-loop control, a control method for controlling at least one of the rear-wheel steering system or the brake system based on a comparison between a measured yaw rate detected by one or more sensors and a reference yaw rate;
when the determined control method is the open-loop control, controlling at least one of the rear-wheel steering system or the brake system in a feed-forward manner based on at least one of a steering angle of a steering wheel, a vehicle speed, and a steering in angle speed of the steering wheel measured by the one or more sensors; and
when the determined control method is the closed-loop control, determining a target yaw rate based on information acquired from the one or more sensors, and controlling at least one of the rear-wheel steering system or the brake system to cause the vehicle to follow the target yaw rate in a feedback manner.

17. The steering control method of claim 16, wherein the selecting of the control method includes:
if the measured yaw rate is less than or equal to the reference yaw rate, outputting a rear-wheel steering input value for controlling steering of rear wheels included in vehicle wheels and a partial braking input value for partially braking one or more of the vehicle wheels to steer the vehicle by the open-loop control to the rear-wheel steering system and the brake system, respectively,
if the measured yaw rate is greater than the reference yaw rate, outputting a rear-wheel steering control signal and a partial braking control signal by the closed-loop control to the rear-wheel steering system and the brake system, respectively.

18. The steering control method of claim 16, wherein:
the vehicle further includes a steer-by-wire system associated with front wheels included in vehicle wheels, and
the steering control method is performed when the steer-by-wire system fails.

19. The steering control method of claim 18, wherein the controlling of at least one of the rear-wheel steering system or the brake system in the feed-forward manner includes:
determining the rear-wheel steering input value for controlling the steering of the rear wheels based on the steering angle of the steering wheel and the vehicle speed and outputting the rear-wheel steering input value to the rear-wheel steering system; and
determining the partial braking input value for partially braking one or more of the vehicle wheels to steer the vehicle based on the steering angle or the steering angle speed of the steering wheel measured by the one or more sensors, and the vehicle speed, and outputting the partial braking input value to the brake system to steer the vehicle by partially braking one or more of the vehicle wheels.

20. The steering control method of claim 19, wherein the rear-wheel steering input value is determined to be proportional to the steering angle of the steering wheel and inversely proportional to the vehicle speed.

21. The steering control method of claim 20, wherein:
the partial braking input value includes a first partial braking input value for compensating for a lack of steering force in association with the rear-wheel steering input value, and
when the steering angle speed of the steering wheel exceeds a threshold steering angle speed, a second partial braking input value for vehicle responsiveness is included in the partial braking input value.

22. The steering control method of claim 21, wherein the second partial braking input value is determined to be proportional to the vehicle speed and a steering angle speed excess value indicative of a degree by which the steering angle speed of the steering wheel exceeds the threshold steering angle speed.

23. The steering control method of claim 22, wherein the first partial braking input value is determined differently depending on whether the steer-by-wire system has a center-locking failure or a free-rolling failure.

24. The steering control method of claim 17, wherein the controlling of at least one of the rear-wheel steering system or the brake system in the feedback manner includes:
generating the rear-wheel steering control signal based on the target yaw rate and outputting the rear-wheel steering control signal to the rear-wheel steering system; and
generating the partial braking control signal for causing the vehicle to follow the target yaw rate and outputting the partial braking control signal to the brake system.

25. The steering control method of claim 17, wherein the controlling of at least one of the rear-wheel steering system or the brake system in the feedback manner includes:
generating the partial braking control signal for causing the vehicle to track the target yaw rate and outputting the partial braking control signal to the brake system; and
generating the rear-wheel steering control signal for compensating for a steering angle of front wheels caused by a scrub radius of the vehicle during partial braking performed in response to the partial braking control signal to the rear-wheel steering system.

26. The steering control method of claim 24, wherein the controlling of at least one of the rear-wheel steering system or the brake system in the feedback manner includes:
outputting the rear-wheel steering control signal for a predetermined period of time to the rear-wheel steering system; and
after the predetermined period of time, outputting the partial braking control signal to the brake system.

27. The steering control method of claim 24, wherein the controlling of at least one of the rear-wheel steering system or the brake system in the feedback manner includes setting a plurality of sections for the steering angle of the steering wheel and setting different sensitivities for each of the plurality of sections to determine the target yaw rate.
